(19) United States
(12) Patent Application Publication
(10) Pub. No.: US 2015/0193808 A1
(43) Pub. Date: Jul. 9, 2015

(54) SYSTEM AND METHOD TO EFFICIENTLY GENERATE ELECTRONIC MARKETING CAMPAIGNS

(71) Applicant: Bryan Wade, Indianapolis, IN (US)

(72) Inventor: Bryan Wade, Indianapolis, IN (US)

(73) Assignee: ExactTarget, Inc., Indianapolis, IN (US)

(21) Appl. No.: 14/150,570

(22) Filed: Jan. 8, 2014

(51) Int. Cl. G06Q 30/02

(52) U.S. Cl. CPC G06Q 30/0241

(57) ABSTRACT

A computerized method and system for efficiently generating a digital marketing campaign is disclosed. The method and system includes receiving, at a server, a request from an enterprise device to generate a marketing campaign using a playbook wizard, providing for display, to the enterprise device, the playbook wizard, the playbook wizard comprising a plurality of prompts to select a recipient list, select a communication template from a database, and select a communication trigger, receiving, at the server, a selection from the enterprise device, the selection identifying at least one recipient list, at least one communication template, and at least one communication trigger, and creating a marketing campaign for each recipient based on the selection.

### PRIORITY

This application claims priority to and the benefit of U.S. Provisional Application No. 61/750,258, filed on Jan. 8, 2013 which is incorporated herein by reference.

### BACKGROUND

Engaging a digital consumer becomes increasingly more difficult each day. As new communication channels, on-line media outlets, and other sources of information become available for consumption, these new avenues compete for the digital consumer's attention. An enterprise interested in maintaining an online marketing relationship with a consumer must consistently present relevant and timely messages in order to stand out among the available media for consumption.

Today, an enterprise may devote an entire marketing team to creating, designing, and implementing marketing campaigns that try to engage with a digital consumer in a relevant way. Through a manual review of available data combined with great effort spent in custom scripting, an enterprise may develop one custom marketing campaign that could be implemented to try to increase engagement. This manual process, however, is costly and slow to implementation. A consumer's interests may have changed from the time the enterprise conceived of the communication to the time that the communication actually is available to the consumer.

For example, if a digital consumer adds items to his or her online shopping cart but fails to ever make a purchase, the enterprise managing the ecommerce website may have an opportunity to further engage the consumer by sending a reminder message about the abandoned shopping cart and the items that the consumer added to it. The enterprise may also include a coupon for one or more of the items abandoned in the shopping cart. In this example, the communication to the consumer is relevant because it is directly reflective of activity the consumer generated on the electronic marketplace, and, thus, the consumer may be more likely to read and respond to the communication.

Nevertheless, implementing an abandoned shopping cart marketing campaign today requires a manual review of available data and custom scripting to target consumers with abandoned shopping carts. That is, implementations today that attempt to engage digital consumers suffer from the inability to quickly and efficiently acquire, onboard, engage, and retain such digital consumers as new communication channels are created and new opportunities for engagement are available. In an attempt to solve this need, enterprises employ entire teams of employees to evaluate engagement channels and draft custom scripts and databases of information for each engagement opportunity and even each communication.

Accordingly, there exists a need for a method and system that enables an enterprise to quickly and efficiently acquire, onboard, engage and retain digital consumers through efficient creation and execution of electronic marketing campaigns.

### BRIEF DESCRIPTION OF THE DRAWINGS

FIG. 1A illustrates a flowchart of a method of efficiently generating marketing campaigns according to at least one embodiment of the present disclosure.

FIG. 1B illustrates a flowchart of a method of efficiently generating marketing campaigns according to at least one embodiment of the present disclosure.

FIG. 1C illustrates a flowchart of a method of efficiently generating marketing campaigns according to at least one embodiment of the present disclosure.

FIG. 2 displays the architecture of a system of efficiently generating marketing campaigns according to at least one embodiment of the present disclosure.

FIG. 3A displays a screenshot of a user interface presented in association with a system and/or method of efficiently generating marketing campaigns according to at least one embodiment of the present disclosure.

FIG. 3B displays a screenshot of a user interface presented in association with a system and/or method of efficiently generating marketing campaigns according to at least one embodiment of the present disclosure.

FIG. 3C displays a screenshot of a user interface presented in association with a system and/or method of efficiently generating marketing campaigns according to at least one embodiment of the present disclosure.

FIG. 3D displays a screenshot of a user interface presented in association with a system and/or method of efficiently generating marketing campaigns according to at least one embodiment of the present disclosure.

FIG. 3E displays a screenshot of a user interface presented in association with a system and/or method of efficiently generating marketing campaigns according to at least one embodiment of the present disclosure.

FIG. 3F displays a screenshot of a user interface presented in association with a system and/or method of efficiently generating marketing campaigns according to at least one embodiment of the present disclosure.

FIG. 4A displays a screenshot of a user interface presented in association with a system and/or method of efficiently generating marketing campaigns according to at least one embodiment of the present disclosure.

FIG. 4B displays a screenshot of a user interface presented in association with a system and/or method of efficiently generating marketing campaigns according to at least one embodiment of the present disclosure.

FIG. 4C displays a screenshot of a user interface presented in association with a system and/or method of efficiently generating marketing campaigns according to at least one embodiment of the present disclosure.

FIG. 4D displays a screenshot of a user interface presented in association with a system and/or method of efficiently generating marketing campaigns according to at least one embodiment of the present disclosure.

FIG. 4E displays a screenshot of a user interface presented in association with a system and/or method of efficiently generating marketing campaigns according to at least one embodiment of the present disclosure.

FIG. 4F displays a screenshot of a user interface presented in association with a system and/or method of efficiently generating marketing campaigns according to at least one embodiment of the present disclosure.

FIG. 4G displays a screenshot of a user interface presented in association with a system and/or method of efficiently generating marketing campaigns according to at least one embodiment of the present disclosure.

FIG. 4H displays a screenshot of a user interface presented in association with a system and/or method of efficiently generating marketing campaigns according to at least one embodiment of the present disclosure.

FIG. 5 displays a screenshot of a user interface presented in association with a system and/or method of efficiently generating marketing campaigns according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in languages such as Java, HTML, Python, C++, C#, or the ASP.Net programming language. However, one of skill in the art will appreciate that other languages may be used instead, or in combination with the foregoing. It should be appreciated that the systems and methods disclosed herein may be combined, implemented, and/or work in conjunction with any of the systems and methods disclosed in U.S. application Ser. No. 10/769,095 filed on Jan. 30, 2004, U.S. application Ser. No. 12/919,982 filed on Aug. 27, 2010, U.S. application Ser. No. 13/254,619 filed on Sep. 2, 2011, and/or International App. No. PCT/US11/64259 filed on Dec. 9, 2011, all of which are incorporated in their entireties herein by reference.

As used herein, communication may include, but is not limited to, an email, MMS, SMS, social media message, direct message, tweet, Facebook message, LinkedIn message, or other type of electronic communication able to be retrieved through a user device, such as, for example, a smartphone, laptop, desktop, or tablet. In the present disclosure, email may be referred to as example types of communications that may be generated through execution of the methods and through the systems herein. Nevertheless, it should be appreciated that the methods and systems described herein may function to generate any communication.

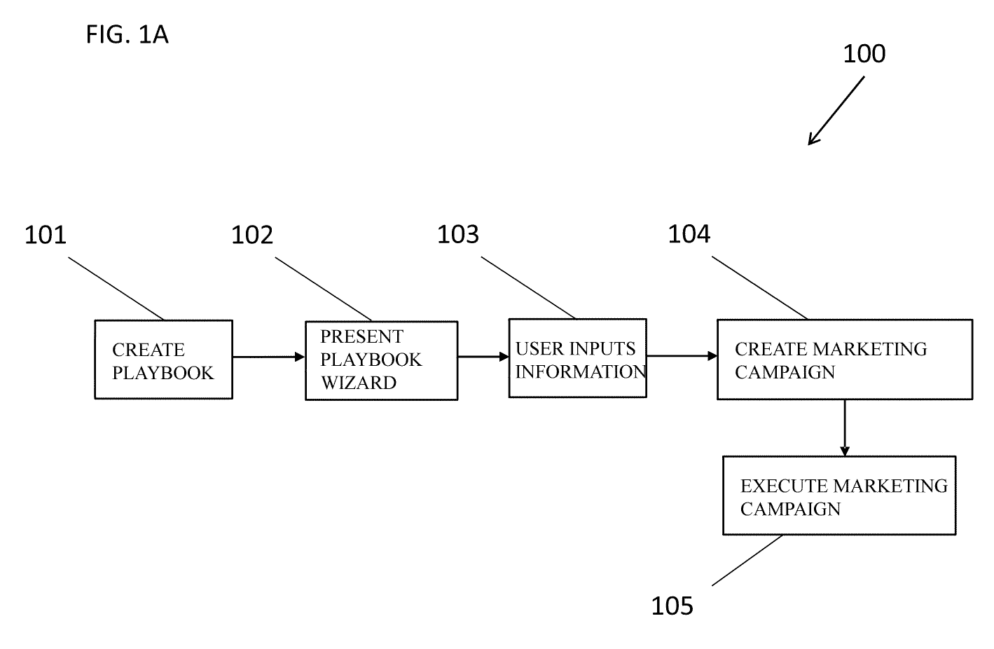

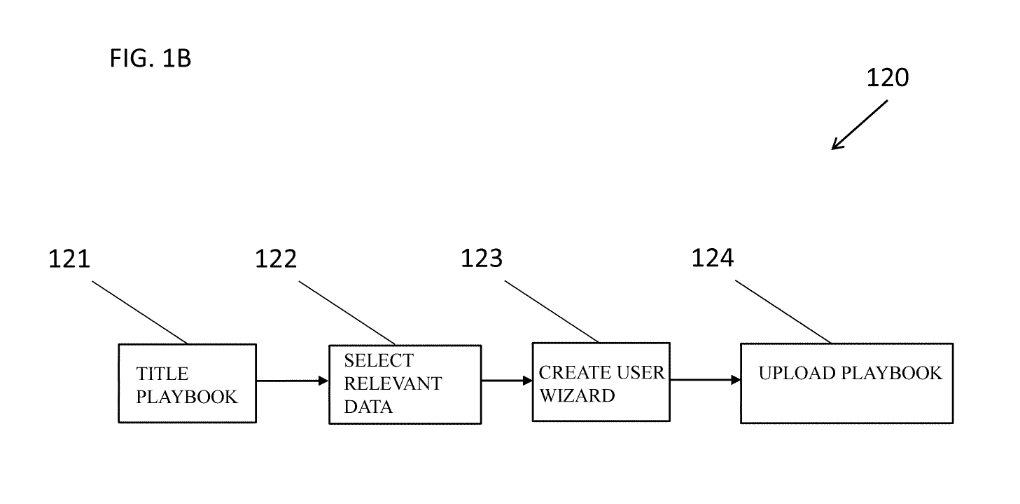

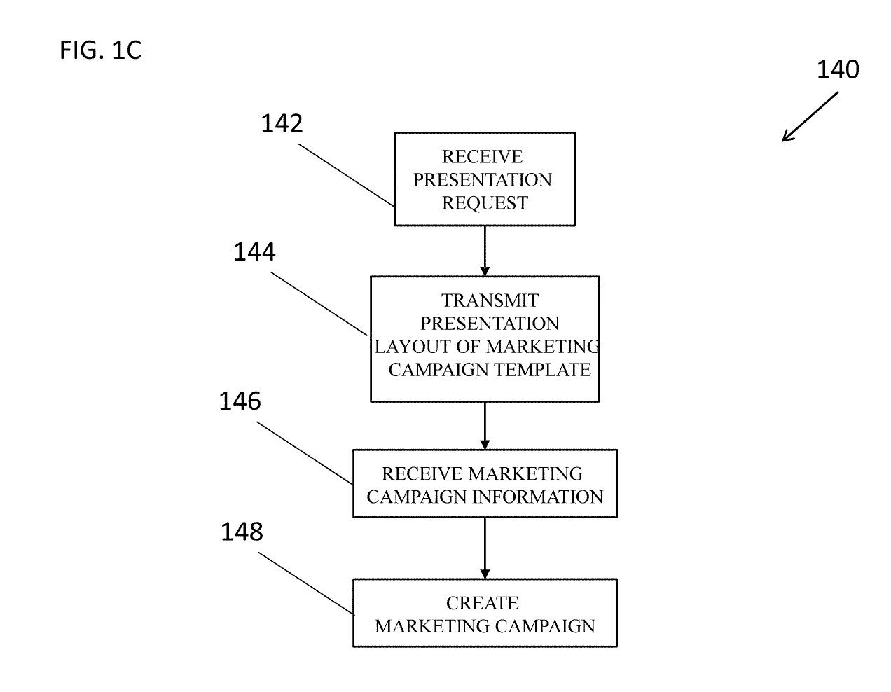

Referring now to FIG. 1, it is shown a method 100 to efficiently generate electronic marketing campaigns according to at least one embodiment of the present disclosure. As shown in FIG. 1, the method 100 includes creating a playbook in step 101, presenting a playbook wizard in step 102, a user inputting information in step 103, creating a marketing campaign in step 104, and executing the marketing campaign in step 105.

In at least one embodiment of the present disclosure, a playbook is created in step 101. As used in the present disclosure, a playbook refers to, but is not limited to, a set of instructions to guide an enterprise through the efficient creation of a marketing campaign. This set of instructions may include, but is not limited to, establishing a list of recipients, defining a cadence of communication, creating or selecting a communication, establishing a trigger for execution, and other types of information related to the creation and execution of a marketing campaign. A playbook may be associated with various information stored for an enterprise, including, but not limited to, contact information for the enterprise, previous communications created by the enterprise, the enterprise's social media presences, email addresses for recipients who have opted in to receiving communications for the enterprise, demographic information of the recipients, and previous sales history (including online shopping cart data) for the recipients on the enterprise's online shopping application. It should be appreciated that a playbook may be associated with whatever data is necessary to effectively create a marketing campaign for an enterprise and that the information stored for the enterprise may be stored in multiple locations and of various formats. It should be appreciated that the playbook efficiently enables the enterprise to create a marketing campaign for such data by prepopulating associations with the data where appropriate.

For example, a playbook may be created to include a set of instructions and requests for information from an enterprise for the creation of a marketing campaign that sends an email to a specific recipient on his or her birthday. In this example, the playbook includes a set of instructions that request pertinent information from an enterprise user in order to create such a marketing campaign. These instructions may include, but are not limited to, defining a set of recipients that the enterprise user would like to send a birthday email, associating a trigger for each recipient to send the email based on the stored recipient's birthday within a database, choosing which communication to send to the recipient, and selecting what, if any, additional communications to send to the recipient as a follow-up to the message. In this example, the playbook, then, requests only the information necessary from the enterprise user in order to create the birthday email marketing campaign.

The present disclosure describes at least one embodiment of the process of creating a playbook in step 101 in more detail in method 120. In at least one embodiment of the present disclosure, the playbook created in step 101 is intended to be distributed in a software-as-a-service model available on the Internet (“SaaS”). By creating the playbook in step 101 and distributing it through a SaaS model, the playbook may be made readily available to any enterprise that desires to efficiently create a digital marketing campaign. It should be appreciated that a playbook may set forth a set of common instructions relevant to a variety of enterprises for creation and execution of similar marketing campaigns. It should be appreciated that the creation of one playbook may be relevant and desirable to multiple enterprises.

In at least one embodiment of the present disclosure, the method 100 includes presenting a playbook wizard in step 102. In at least one embodiment of the present disclosure, the playbook wizard is presented to an enterprise user through a SaaS application available on the Internet. In such an embodiment, the enterprise user accesses the playbook wizard through a web browser or electronic application from a device, such as, for example, a smartphone, personal computer, laptop, tablet, or other computing device. In such an embodiment, the enterpriser user accesses the playbook wizard

In at least one embodiment of the present disclosure, a playbook wizard may only be presented in step 102 to an authorized user. In such an embodiment, an enterprise intending to access the playbook wizard in step 102 may be required to authenticate prior to accessing the playbook wizard. Authentication may include, but is not limited to, username/password, certificate, token, and other forms of authentication. In such an embodiment, the enterprise user authenticates to a SaaS application which authorizes the user to access the playbook wizard. In such an embodiment, the playbook wizard, then, associates input provided by the enterprise user with information previously obtained and stored for the enterprise, such as, for example, information available through one or more data repositories, contact databases, CRM, Data.com. Information also may be integrated within the playbook wizard from platforms that provide application programming interfaces or other integration opportunities for data retrieval, such as, for example, ExactTarget FUEL, Force.com, Heroku, and others. For example, the playbook wizard may be provided to an enterprise by an organization that assists the enterprise with creation and execution of a marketing campaign. If the organization assists the enterprise with its marketing campaigns, the organization may have information stored about previously executed marketing campaigns and recipients in which the enterprise sends marketing communications.

In at least one embodiment of the present disclosure, the method 100 includes an enterpriser user inputting information in step 103. In such an embodiment, the enterprise user follows the playbook wizard and inputs information requested through the wizard. Information requested by the step-by-step wizard may include, but is not limited to, a set of recipients, email communications to include in the marketing campaign, a cadence, and other information necessary for the creation and execution of marketing campaigns.

In at least one embodiment of the present disclosure, the information input by the user in step 103 includes the selection and/or creation of a set of recipients. In such an embodiment, the user may choose a set of recipients from a database of stored recipients from various channels and apply filtering criteria to the set of stored recipients to obtain the desired to recipient list. In such an embodiment, the user may select and apply filtering criteria to various databases of stored recipients and may combine various sources of stored recipients with various filtering criteria in order to obtain the desired recipient list. As used in the present disclosure, filtering criteria may include, but is not limited to, demographic information, such as, for example, geographic location, residence, hair color, sex, age, income, job status, and others, date in which the recipient opted into receiving communications from the enterprise, whether the recipient has opted into receiving communications from the enterprise, Internet Protocol address, type of device (mobile, laptop, personal computer, tablet, etc.), email address, email domain, and other types of information that differentiates one contact from another.

In at least one embodiment of the present disclosure, the user may select a set of recipients based upon information stored in a data extension. As used in the present disclosure, a data extension may include, but is not limited to, a table within an application layer that contains information from disparate sources and/or a database view. A data extension enables an enterprise to join information from various sources in order to present a selectable set of information that is relevant to the playbook. For example, if an enterprise stores information about recipients in one database which includes the recipient's zip code in which they reside and the recipient's full name, but the enterprise stores information in a disparate database that includes every zip code in the United States matched with the city and State associated with the zip code, then the enterprise may create a data extension to combine the two disparate data sources and produce a data source that includes the recipient's full name and the city and State in which they reside. It should be appreciated that data extensions are one data type available to the user when inputting information in step 103 and that other data types and data sources may be used.

For example, if the user is creating a playbook for use in a scenario where a recipient has abandoned a shopping cart on the enterprise's online purchasing platform, the enterprise may select a set of recipients from consumers with shopping carts that are associated with timed-out sessions from the online purchasing platform and/or consumers with shopping carts that have not been modified for a specific period of time, such as, for example, a day. In this example, the enterprise would select these recipients by choosing from various data sources and applying certain filtering criteria to arrive at the recipient list provided in step 103.

In at least one embodiment of the present disclosure, the user creates communication content in step 103 to be used in the marketing campaign created by the playbook. In such an embodiment, the user may create content to include in communications sent from the marketing campaign generated by the playbook. In such an embodiment, content may include, but is not limited to, dynamic content, live content, and static content. A user creating content may include pictures, text, videos, procedurally generated content pulled from external sources from the communication, interactive objects, such as, for example Flash and HTML5. It should be appreciated that content may include various types of materials sent in communications to recipients within a marketing campaign. For example, in the event that the user is following a playbook wizard for a marketing campaign that sends an email to a recipient on his or her birthday, the user may create content including text that says “Happy Birthday”, a picture of a birthday cake, a video embedded within the communication that plays a song, and a live content area that pulls the latest prices from the enterprise's website for popular products.

It should be appreciated that the content created in step 103 may be designed to be most relevant for a recipient at the time of sending an actual communication through execution of the playbook. Accordingly, the playbook wizard may enable the enterprise to select content that is dynamically generated at the time of sending the communication, content that is generated at the time the end recipient actually opens the communication, and other types of active content. It should be appreciated, therefore, that this active content enables the enterprise to create an enterprise marketing campaign that will create and send communications that have the capability to include relevant content even if the marketing campaign is generated days, weeks, or months prior to communications being sent through its execution.

In at least one embodiment of the present disclosure, the user selects pre-generated communications to use in the playbook in step 103. In such an embodiment, previously developed communications may be presented to the user for selection and/or modification. Communications may include, but are not limited to, social media messages, SMS messages, emails, and tweets with specific hashtags and/or mentions. In such an embodiment, the user may select previously created communications used in other marketing campaigns and, if necessary, modify the content within each communication to fit the purpose of the marketing campaign that will be created through the execution of the playbook.

In at least one embodiment of the present disclosure, the user may create multiple communications through multiple communication channels in step 103. For example, the user may choose to include a Facebook message, an email, and a tweet within the communications provided in step 103 to be included in the marketing campaign resulting from execution of the playbook. In such an embodiment, the user may select individual content to be included in the multiple communications.

In at least one embodiment of the present disclosure, the user may choose to send multiple communications to recipients on a schedule, such as, for example, three emails over the period of three weeks. In such an embodiment, the user may create and/or select content to populate the multiple communications. In at least one embodiment of the present disclosure, the user may select pre-generated schedules to send the communications or create a new schedule. In such an embodiment, the user may select a pre-rendered cadence to send communications in step 103. Pre-rendered cadences may include, but are not limited to, best practices previously defined by a marketing team, a previously used schedule for a similar marketing campaign, or a set of pre-rendered schedules that follow commonly used cadences. In at least one embodiment of the present disclosure, the user may create a new cadence for each communication. It should be appreciated that the user may input information in step 103 through a variety of ways. For example, the user may access and interact with a SaaS application available on the Internet.

In at least one embodiment of the present disclosure, the method 100 includes creating a marketing campaign in step 104. In such an embodiment, the combination of the playbook created in step 101 and the information input by the enterprise user in 103 provides enough information to create a marketing campaign. This process will provide the marketing campaign with the list of recipients to send communications, which communications to send, when to send communications, and what events trigger execution of the marketing campaign. In at least one embodiment of the present disclosure, the method 100 includes executing the marketing campaign in step 105. In such an embodiment, the marketing campaign generated in step 104 is executed in step 105 based upon the criteria provided within the marketing campaign.

For example, a playbook may be designed to create a marketing campaign that attempts to obtain an opt-in email address from a recipient who chooses to Follow the enterprise's Twitter handle. In this example, the playbook is created is step 101 by creating the list of instructions necessary to execute the marketing campaign with this goal. For example, in step 101, the playbook is designed to interact with Twitter's API to obtain a list of Twitter handles that have followed the enterprise's Twitter handle. In step 101, the playbook is designed to obtain a list of all new Twitter handles that have followed the enterprise's Twitter handle over a particular period time, such as, for example, each day. Next, in step 102, a playbook wizard is presented to an enterprise user to provide the necessary information in step 103 to create and execute a marketing campaign.

Referring now to FIG. 1B, it is shown a method 120 to efficiently create digital marketing campaigns according to at least one embodiment of the present disclosure. As shown in FIG. 1B, the method 120 includes creating a playbook title in step 121, selecting relevant data to be associated with the playbook in step 122, create a wizard to be populated by a user in step 123, and uploading the playbook to a repository in step 124.

In at least one embodiment of the present disclosure, a playbook is initiated by creating a title for the playbook in step 121. In such an embodiment, the name associated with the playbook may be merely for identification purposes and serves only to initiate the process of creating the playbook. In at least one embodiment of the present disclosure, relevant data to be used in the playbook is selected in step 122. In such an embodiment, relevant data for the playbook may vary based on the business goals of the marketing campaign to be created by the execution of the playbook by the user.

A playbook may be created to generate various marketing campaigns to solve various business needs. In one example, a playbook may be created to generate a marketing campaign designed to acquire new customers for the enterprise by asking recipients to provide further information to the enterprise. In this example, a marketing campaign may be designed to ask a customer for his or her email address through a communication avenue known to the enterprise. For example, if the enterprise has obtained the customer's mobile device number, the resulting marketing campaign may send one or more SMS messages to the customer asking for the customer to provide further information, like an email address, to opt in to receiving communications by the enterprise. In this example, the data relevant for the playbook may be a database in which customer mobile numbers and email addresses are stored filtered to only include customer mobile numbers where there is no associated email address.

In another example, a playbook may be created to generate a marketing campaign designed to onboard a newly acquired customer in order to provide relevant and pointed information to establish a relationship between the customer and the enterprise in a way that encourages engagement and further association with the enterprise's brand. For example, the marketing campaign may send a series of helpful communications to a newly acquired customer that direct the customer to how-to guides about the enterprise, exclusive coupons and deals for newly acquired customers, and other types of onboarding content that may promote engagement with the brand by the newly acquired customer. In this example, data relevant to the playbook may include a customer's email address, the date in which the customer opted in to receiving communications from the enterprise, and other information.

In another example, a playbook may be created to generate a marketing campaign that attempts to convert prospective customers into actual customers or expand relationships with existing customers. For example, the marketing campaign may send a relevant and timely communication to a customer that is personal to that customer, such as, for example, an email wishing the customer a happy birthday on his or her birthday. In this example, the relevant data to the playbook may be a customer's email address and birthday.

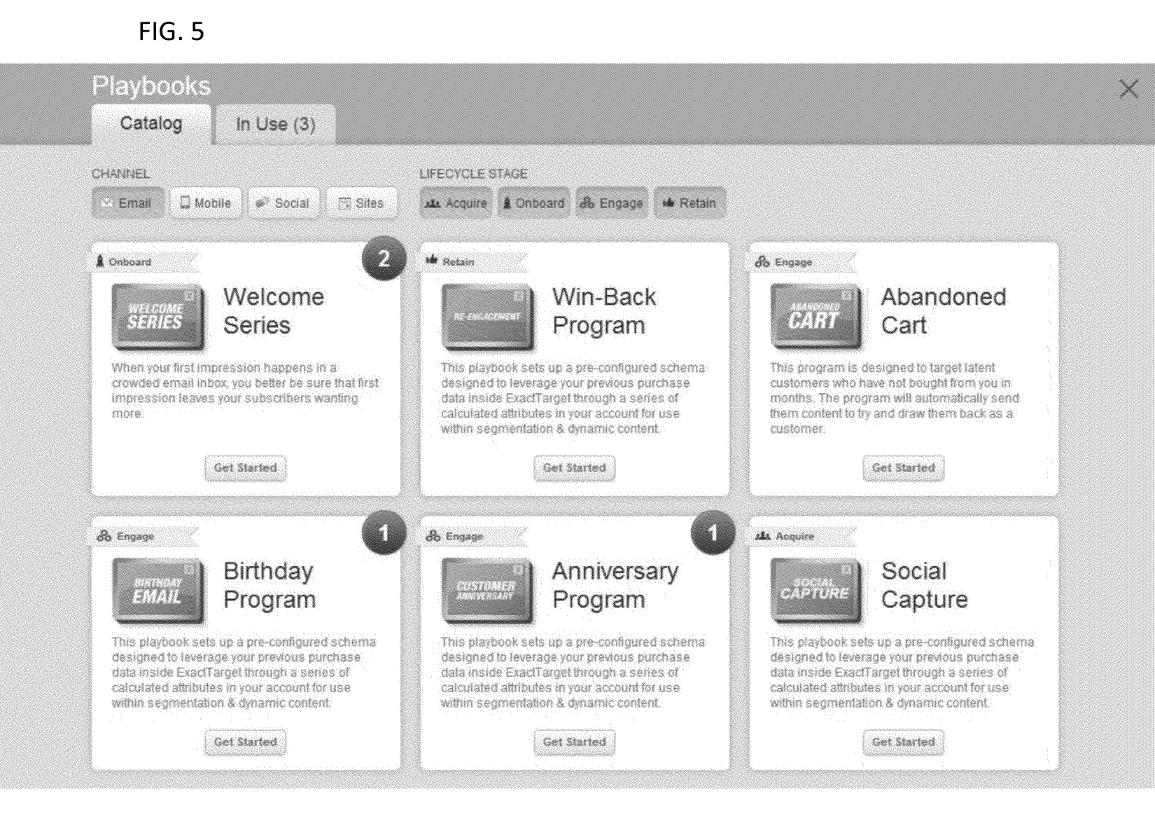

In another example, a playbook may be created to generate a marketing campaign that attempts to retain customers that have lost engagement with the enterprise's brand or have failed to execute steps towards engagement with the brand in one or more ways. For example, the marketing campaign may identify customers on an enterprise's shopping portal that have left items within a shopping cart and failed to make a purchase. In this example, the relevant data to the playbook may be customer shopping cart information, purchase history, and email address. Examples of the types of playbooks that can be created to efficiently generate digital marketing campaigns are shown on FIG. 5. The enterprise may further purchase advertisements that are directed towards such customers based on information known about the customer through one or more advertising outlets, such as, for example, SOCIAL.COM.

In at least one embodiment of the present disclosure, the relevant data selected in step 122 may include data sources and not specific data types or elements. In such an embodiment, the relevant data selected in step 122 may include one or more data repositories where customer information is included for an enterprise user and, therefore, enable the enterprise user to select the information relevant to the enterprise user during execution of the playbook. It should be appreciated that the relevant data selected in step 122 may be any data that would assist in accomplishing the business goals set forth in the creation of the playbook. This data may be stored in various data sources, may be combined from multiple data sources, and may be further configurable by the enterprise user. Data sources that may be referenced include, but are not limited to, Salesforce CRM, proprietary data within internal datastores in the enterprise, third party data sources accessible through application programming interfaces, DATA.COM, social networking outlets, and others. It should be appreciated that the playbook is designed to provide a step by step guide to the enterprise to assist in efficient creation of a marketing campaign and that an enterprise may choose to modify or otherwise alter the relevant data selected for the playbook during its creation. Thus, the playbook serves as a guide for efficient creation of a marketing campaign and may be altered by the enterprise as needed.

In at least one embodiment of the present disclosure, a user wizard is generated in step 123. In such an embodiment, a step-by-step guide in the form of a wizard is created to easily facilitate creation of a marketing campaign by an enterprise user. A step-by-step wizard may include any number of steps necessary to populate a recipient list, create and/or select content for inclusion in communications, select a schedule, and otherwise set forth parameters to facilitate creation and execution of a marketing campaign with the playbook. In at least one embodiment of the present disclosure, the user wizard is created to be served through a web server in a SaaS model available on the Internet. In such an embodiment, the step-by-step wizard is designed to be executed and interacted with by the enterprise user through an Internet-capable device.

In at least one embodiment of the present disclosure, the playbook is uploaded in step 124. In such an embodiment, the playbook is uploaded to a playbook repository where it may be served to an enterprise user for execution. In such an embodiment, the playbook may be stored in a relational database, web service, web structure, and/or file repository.

Referring now to FIG. 1C, it is shown a flowchart according to at least one embodiment of the present disclosure of a method 140 for efficiently generating a marketing campaign. As shown in FIG. 1C, the method 140 includes receiving a presentation request in step 142, transmitting a presentation layout of a marketing campaign template in step 144, receiving a marketing campaign information in step 146, and creating a marketing campaign in step 148.

In step 142, according to at least one embodiment of the present disclosure, a server receives a presentation request from an enterprise device for presentation of a marketing campaign template. In such an embodiment, the presentation request may be, but is not limited to, a protocol request over a computer network from the enterprise device to the server requesting that the server transmit the marketing campaign template for rendering at the enterprise device. In such an embodiment, the enterprise device may additionally pass authentication credentials and/or proof of authorization (i.e. session cookie) to the server in the presentation request and the server may verify the authenticity and/or authorization of the enterprise device.

In step 144, according to at least one embodiment of the present disclosure, the server may transmit a presentation layout of a marketing campaign template to the enterprise device over a computer network. In such an embodiment, the presentation layout may include a website, webpage, web service, application, or other consumable medium from the server to the enterprise device. In such an embodiment, the marketing campaign template may include one or more dialog boxes or other interactive structure to request from the enterprise device information to generate a marketing campaign. In at least one embodiment of the present disclosure, the marketing campaign template is a playbook previously configured at the server to take as inputs information from one or more enterprise devices and create a marketing campaign from the information, such as, for example, by associating information provided by the enterprise device with information previously known to create communications for sending to recipients.

In at least one embodiment of the present disclosure, the enterprise device presents marketing campaign information to the server in step 146. The marketing campaign information may include, but is not limited to, a communication template, a mailing list or data extension, a communication trigger, a marketing campaign name, and other information. The communication trigger may include, but is not limited to, a date, a data attribute associate with one or more recipients in a mailing list or data extension stored in a database, a purchase activity, an indication that one or more recipients has abandoned an online shopping cart, or other information. In at least one embodiment of the present disclosure, the enterprise device may provide the marketing campaign information through the presentation layout of the marketing campaign template as presented in steps 144.

In at least one embodiment of the present disclosure, a marketing campaign is created in step 148. In such an embodiment, a marketing campaign may be created by the server through the inputs provided by the enterprise device associated with the marketing campaign template. In such an embodiment, the marketing campaign may be stored in a database. The marketing campaign may also be activated immediately or activated at a later time based on selection through the enterprise device. In the event that the marketing campaign is activated immediately, the marketing campaign may generate one or more communications to recipients within the mailing list or data extension based on the communication template.

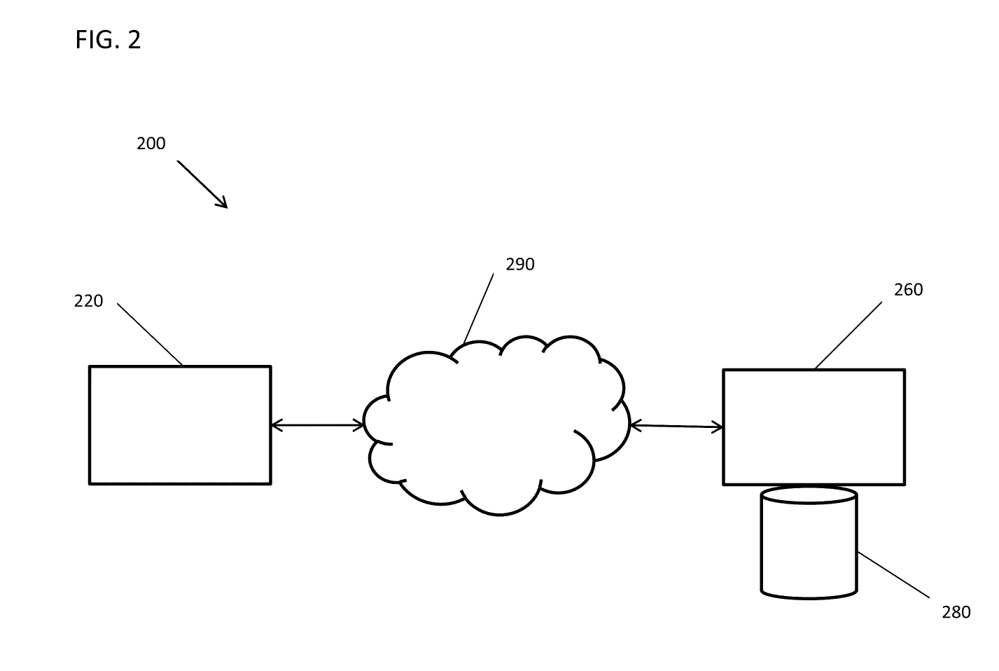

Referring now to FIG. 2, there is shown at least one embodiment of the components of the system for efficiently generating marketing campaigns 200 according to the present disclosure. System 200 comprises first remote device 220, host server 260, database 280, and computer network 290. For purposes of clarity, only one first remote device 220 is shown in FIG. 2. However, it is within the scope of the present disclosure that the system 200 may have two or more first remote devices 220 operating at the same time. In the embodiment shown in FIG. 2, first remote device 220 is operated by an enterprise. It should be noted that at least in one embodiment of the present disclosure, the first remote device 220 may not be remote from the other components of the system 200 but may be part of or locally connected to the host server 260 and the database 280.

The first remote device 220 may be configured to send content to the host server 260 via the computer network 290. In addition or alternatively, the first remote device 220 may be configured to access and utilize an application hosted on host server 260 to build content, communications, and/or a marketing campaign. First remote device 220 includes one or more computers, computing devices, or systems of a type well known in the art, such as a mainframe computer, workstation, personal computer, laptop computer, hand-held computer, cellular telephone, or personal digital assistant. First remote device 220 comprises such software, hardware, and componentry as would occur to one of skill in the art, such as, for example, one or more microprocessors, memory systems, input/output devices, device controllers, and the like. First remote device 220 also comprises one or more data entry means (not shown in FIG. 2) operable by users of first remote device 220 for data entry, such as, for example, a pointing device (such as a mouse), keyboard, touchscreen, microphone, voice recognition, and/or other data entry means known in the art. First remote device 220 also comprises a display means (not shown in FIG. 2) which may comprise various types of known displays such as liquid crystal diode displays, light emitting diode display, and the like upon which information may be display in a manner perceptible to the user.

As described above, the host server 260 may be configured to receive content from the first remote device 220, host an application for the first remote device 220 to build electronic messages, create marketing campaigns, and/or establish one or more electronic messages. In at least one embodiment, the host server 260 accesses the database 280 to associate marketing campaigns with stored recipient information as described in the method 100. The host server 260 is configured to carry out one or more of the steps of methods described herein. For example, the host server 260 may perform steps 101, 102, 104, and 105 of the method 100. It should be appreciated that the host server 260 may perform any or all of the steps of the methods disclosed herein.

The first remote device 220 is configured to provide input to the host server 260 to carry out one or more of the steps of the methods described herein. Host server 260 comprises one or more server computers, computing devices, or systems of a type known in the art. Host server 260 further comprises such software, hardware, and componentry as would occur to one of skill in the art, such as, for example, microprocessors, memory systems, input/output devices, device controllers, display systems, and the like. Host server 260 may comprise one of many well-known servers, such as, for example, IBM's AS/400 Server, IBM's AIX UNIX Server, or MICROSOFT's WINDOWS NT Server. In FIG. 2, host server 260 is shown and referred to herein as a single server. However, host server 260 may comprise a plurality of servers or other computing devices or systems interconnected by hardware and software systems know in the art which collectively are operable to perform the functions allocated to host server 260 in accordance with the present disclosure.

The database 280 is configured to store data extensions, contact attributes, recipient demographic information, content, and other information. Database 280 is “associated with” host server 260. According to the present disclosure, database 280 can be “associated with” host server 260 where, as shown in the embodiment in FIG. 2, database 280 resides on host server 260. Database 280 can also be “associated with” host server 260 where database 280 resides on a server or computing device remote from host server 260, provided that the remote server or computing device is capable of bi-directional data transfer with host server 260. In at least one embodiment, the remote server or computing device upon which database 280 resides is electronically connected to host server 260 such that the remote server or computing device is capable of continuous bi-directional data transfer with host server 260.

For purposes of clarity, database 260 is shown in FIG. 2, and referred to herein as a single database. It will be appreciated by those of ordinary skill in the art that database 260 may comprise a plurality of databases connected by software systems of a type well known in the art, which collectively are operable to perform the functions delegated to database 260 according to the present disclosure. Database 260 may comprise a relational database architecture or other database architecture of a type known in the database art. Database 260 may comprise one of many well-known database management systems, such as, for example, MICROSOFT's SQL Server, MICROSOFT's ACCESS, or IBM's DB2 database management systems, or the database management systems available from ORACLE or SYBASE. Database 260 retrievably stores information or documents that are communicated to database 260 from first remote device 220 or through computer network 290.

First remote device 220 communicates with host server 260 via computer network 290. The communication between first remote device 220 and host server 260 may be bi-directional. Computer network 290 may comprise the Internet, but this is not required.

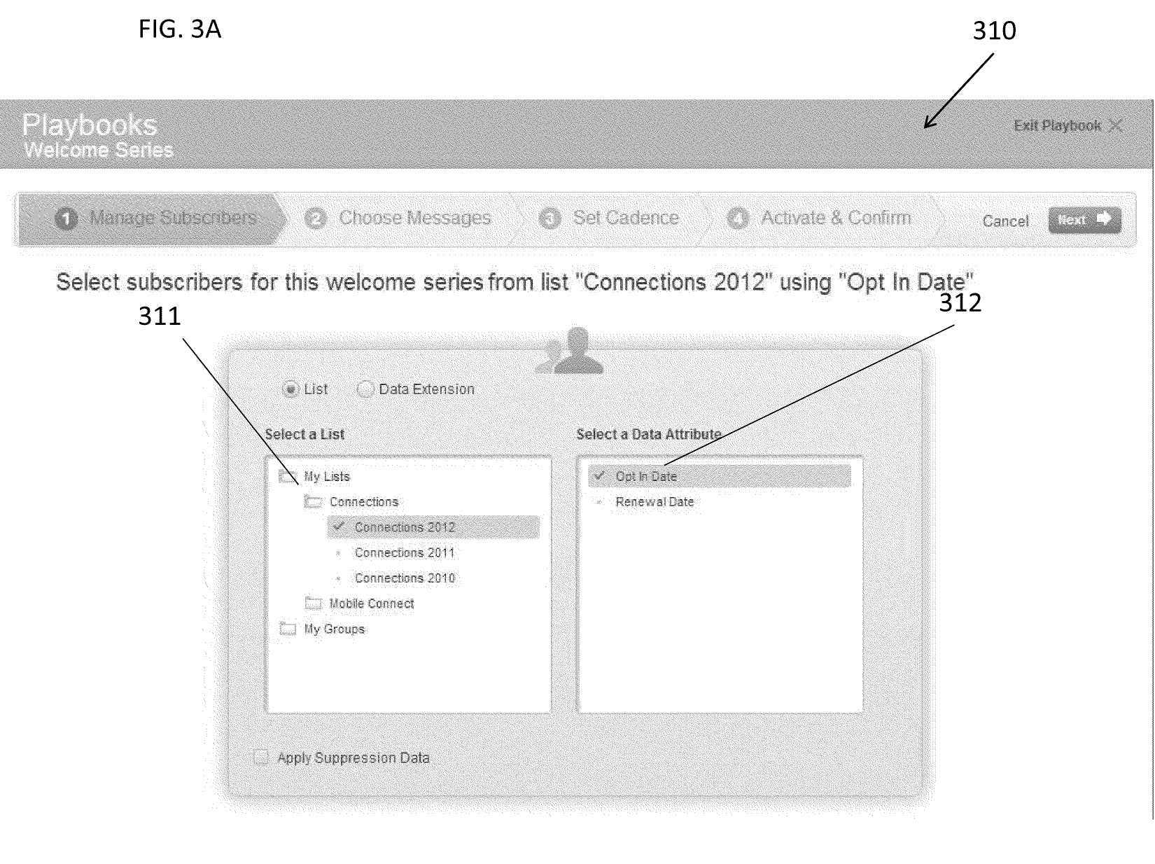

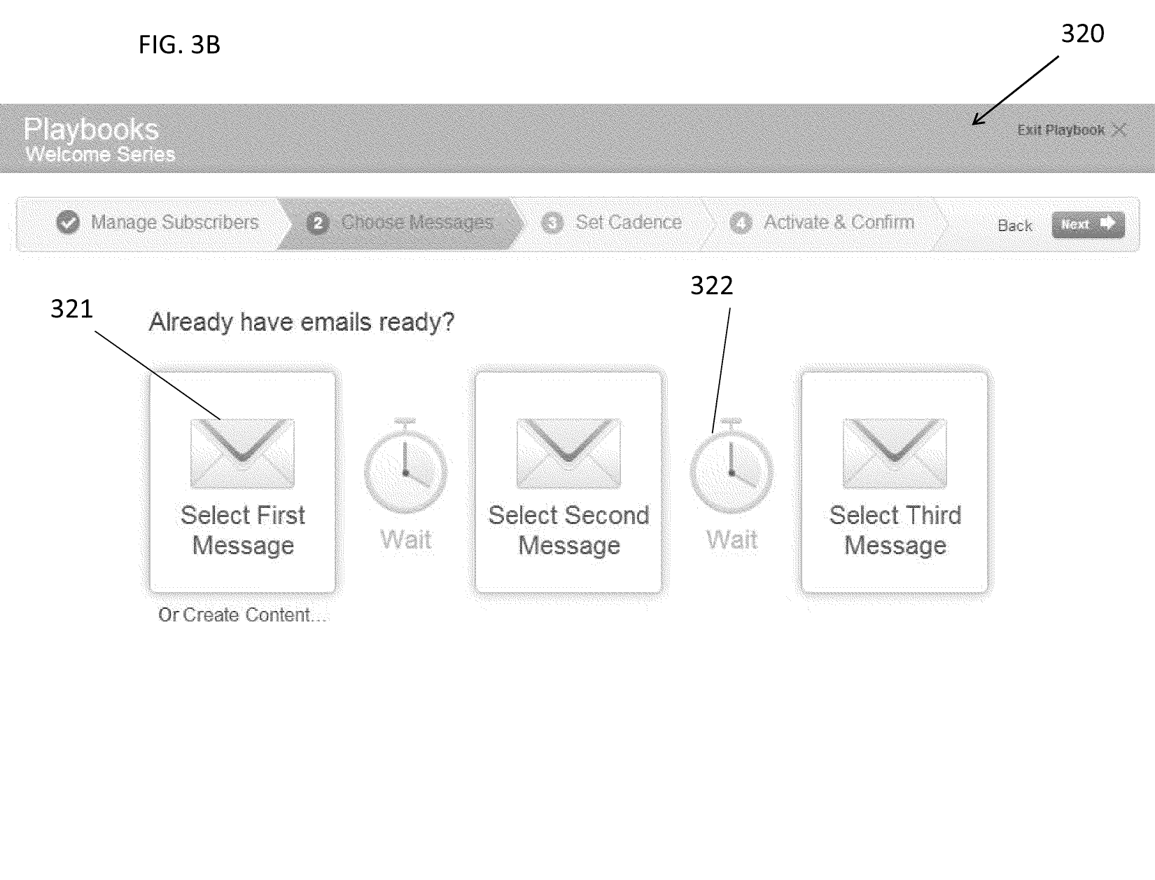

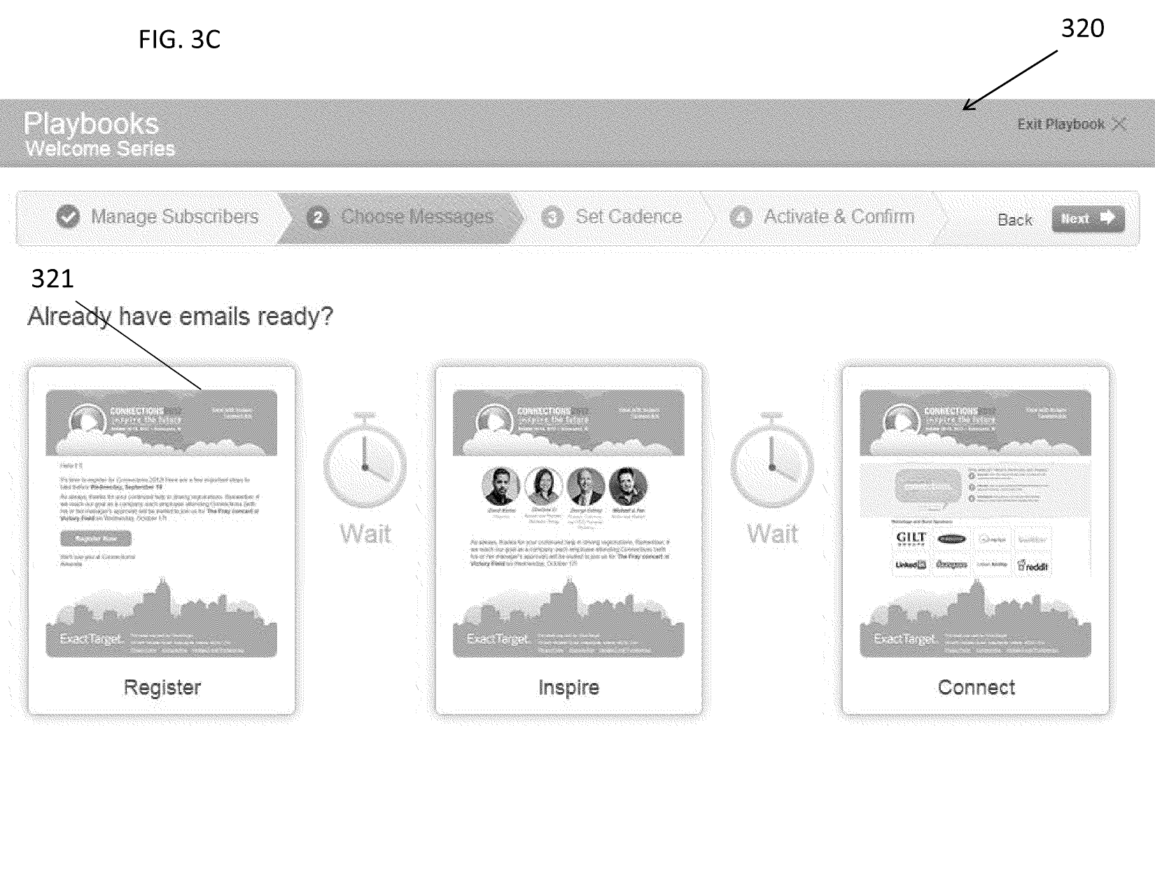

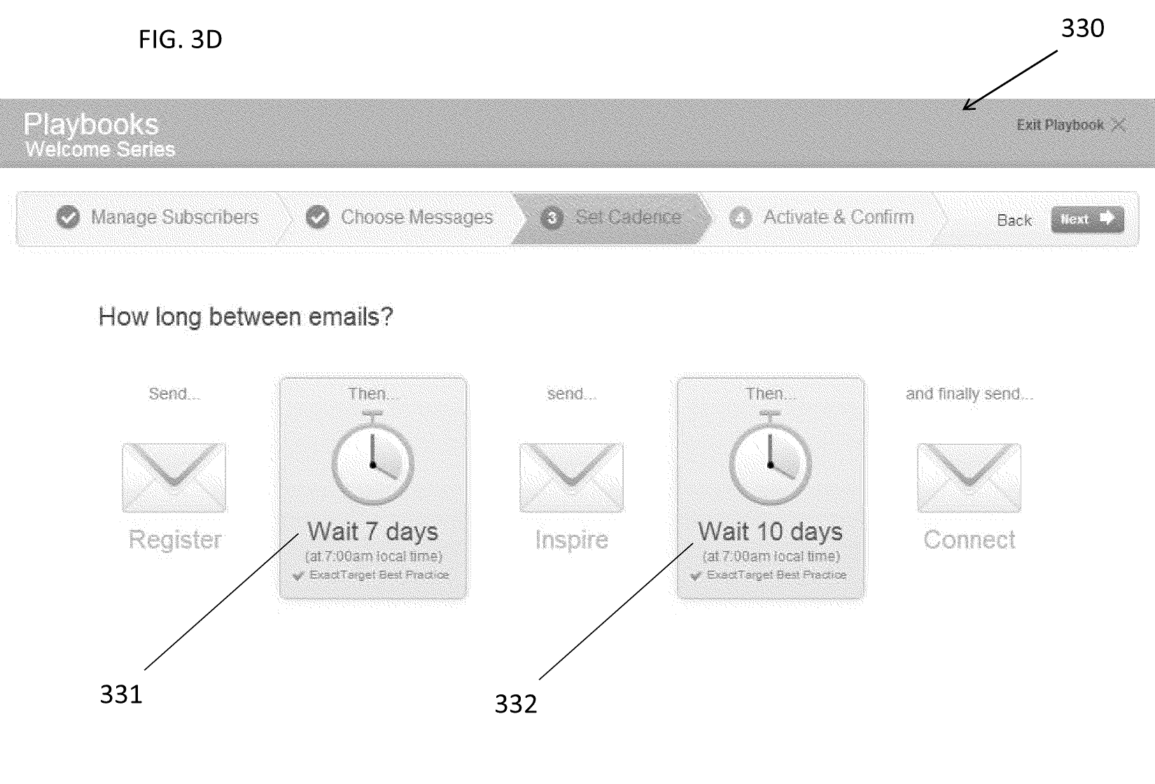

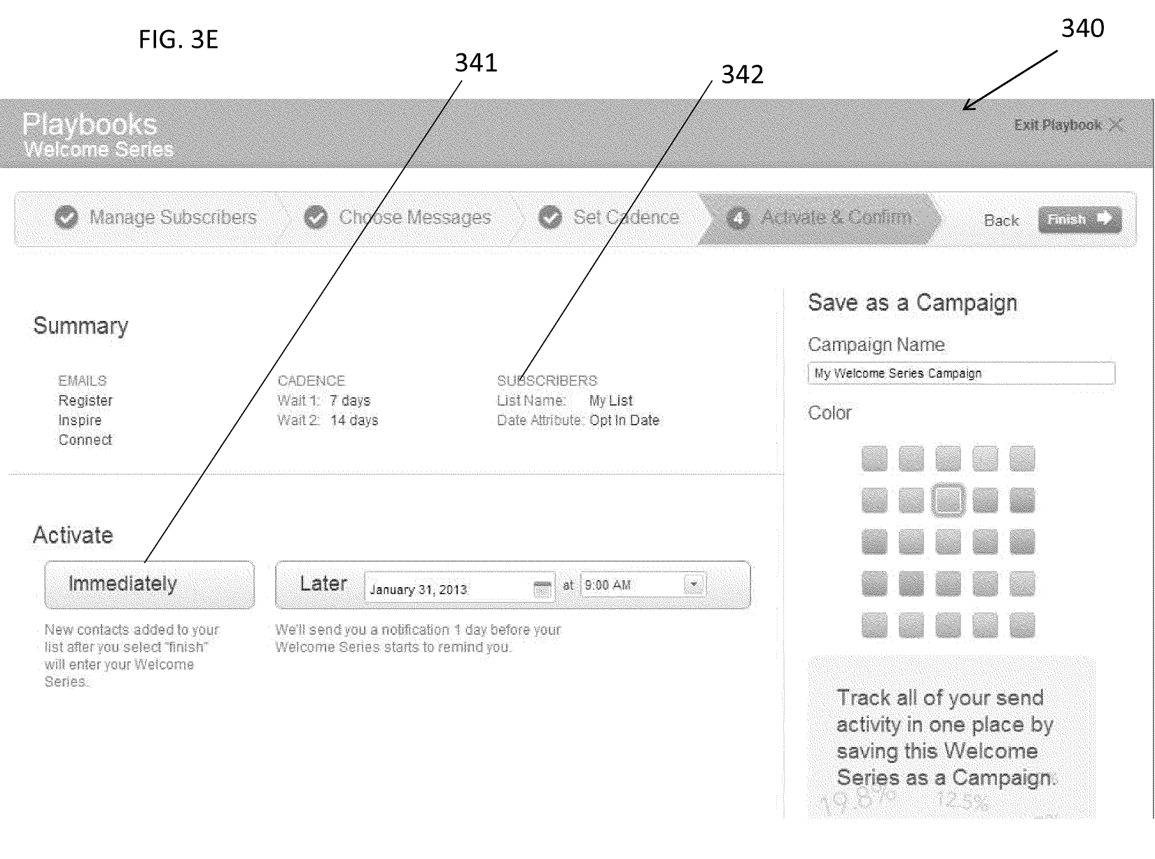

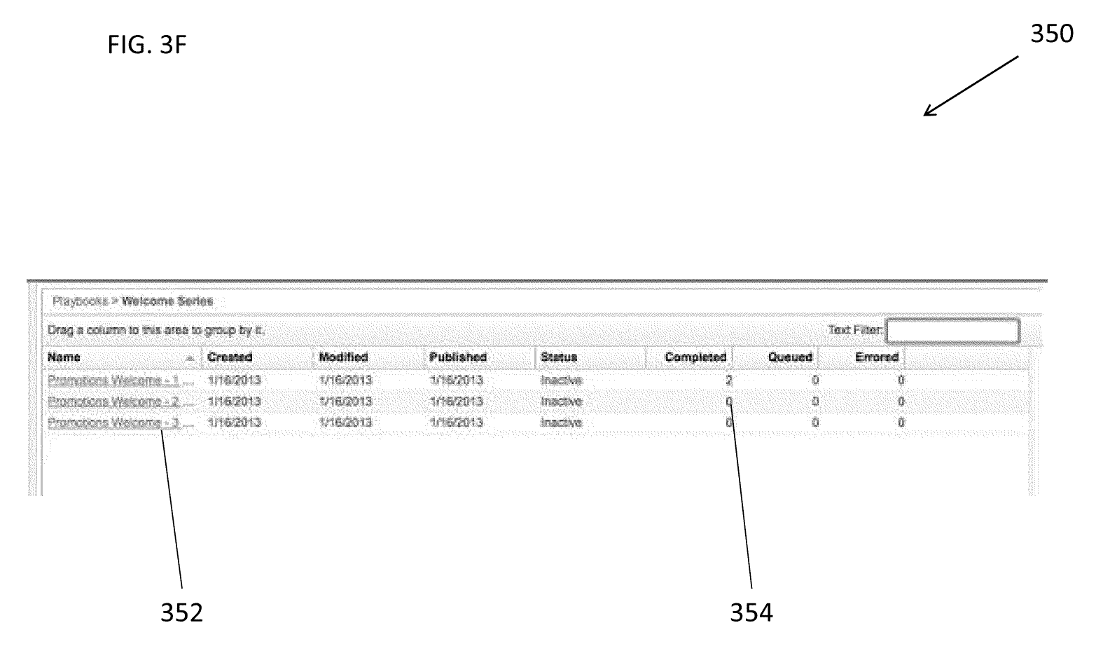

Referring now to FIG. 3A, it is shown a screenshot of a graphical-user interface 310 of a method and system to efficiently generate digital marketing campaigns according to at least one embodiment of the present disclosure. As shown in FIG. 3A, the graphical user interface 310 displays a point-in-time representation of an example of an interface presented to an enterprise user during execution of a playbook through a SaaS application. The graphical-user interface 310 is one example of the type of interface made available to an enterprise user during execution of the method 100 shown in FIG. 1A through the system 200 shown in FIG. 2. For example, the graphical-user interface 310 is an example of the interface displayed to the enterprise user for the enterprise user to provide information in step 103 of the method 100, and the graphical user interface 310 is one example of the result of creation of the playbook wizard in step 102.

The example graphical user interface 310 shown in FIG. 3A represents one of many of the types of playbook wizards available to be executed by an enterprise user to efficiently generate a marketing campaign. The example shown in FIGS. 3A, 3B, 3C, and 3E represents a playbook designed to generate a marketing campaign with the business goal of providing onboarding resources to a newly acquired customer. It should be appreciated that the example data and screenshots provided in these FIGs are merely examples.

In at least one embodiment of the present disclosure, the graphical-user interface 310 displays a panel 311 to select a recipient list and a filtering panel 312. In such an embodiment, the panel 311 enables an enterprise user to select a list of recipients to receive communications through a marketing campaign. The panel 311 shown in FIG. 3A presents multiple distribution lists stored for the enterprise. In this example, the distribution lists correspond to a yearly conference in which the enterprise obtained opt in and contact information of customers. The panel 311 in this example also represents other groups that the enterprise user may select as recipients of communications in the marketing campaign. The panel 311 also enables the enterprise user to select a data extension. In at least one embodiment of the present disclosure, the panel 311 may include other data sources, data elements, pre-populated lists, and/or allow the enterprise to create a new list.

In this example, the graphical-user interface 310 also includes a filtering panel 312. In this example, the filtering pane 312 enables an enterprise user to filter and/or choose certain data attributes as relevant to the marketing campaign to be generated by the playbook. In this example, the enterprise user has selected that the “Opt In Date” as relevant in the filtering panel 312. By selecting this data attribute in the filtering panel 312, the enterprise user may filter recipients from the panel 311.

Referring now to FIG. 3B, it is shown a graphical-user interface 320 of a method and system to efficiently generate digital marketing campaigns according to at least one embodiment of the present disclosure. In the graphical-user interface 320, it is displayed an example of a playbook where a user is requested to input multiple messages 321 to send in execution of a marketing campaign and a schedule 322 to send the multiple messages 321. In this example, the multiple messages 321 may be selected from previously generated message content or may be created directly within the graphical-user interface 320 by selecting the “Create Content” link. In this example, the schedule 322 may be selected from a list of pre-populated schedules or be manually defined by an enterprise user. Referring now to FIG. 3C, it is shown the graphical user interface 320 where multiple messages 321 have been populated to include in the marketing campaign generated by execution of the playbook. In this example, three messages 321 have been selected and/or created through the graphical-user interface 320.

Referring now to FIG. 3D, it is shown a graphical-user interface 330 of a method and system to efficiently generate digital marketing campaigns according to at least one embodiment of the present disclosure. As shown in FIG. 3D, the graphical-user interface 330 includes parameters 331, 332 that indicate how long to wait in between sending the selected messages. In this example, the first parameter 331 is selected to wait seven days in between sending the first message and the second message. As shown in this example, the first parameter 331 is a pre-loaded schedule based on best practices provided by the system. In this example, the second parameter 332 is selected to wait ten days in between sending the second message and the third message. As shown in the third parameter 332, this period is a pre-loaded schedule that corresponds to best practices provided by the system.

Referring now to FIG. 3E, it is shown a review page 340 presented by execution of a method and system to efficiently generate digital marketing campaigns according to at least one embodiment of the present disclosure. As shown in FIG. 3E, the review pane includes all aspects of the marketing campaign that will be generated by completion of the playbook, including the message selected, the message schedule, the name of the marketing campaign, when to activate the marketing campaign, and other parameters that may be necessary to create and execute a marketing campaign.

Referring now to FIG. 3F, it is shown a statistics page presented by execution of a method and system to efficiently generate digital marketing campaigns according to at least one embodiment of the present disclosure. As shown in FIG. 3F, the statistics page 350, includes a listing 352 of all playbooks under the “Welcome Series” example generated through the SaaS environment. For example, as shown in FIG. 3F, an enterprise has created three playbooks directed to the “Welcome Series” which are displayed in the statistics page 350. In this example, each of the playbooks in the listing 352 may be directed to a different set of consumers identified through different recipient lists and/or data extensions as discussed previously. The playbooks may also include different content from each other. It should be appreciated, of course, that the playbooks created and shown in the listing 352 may share content, recipients, and other information and that the statistics page 350 shows the available playbooks for review by the enterprise.

As shown in the statistics page 350, an enterprise may review operational information 354 regarding all playbooks created through a SaaS and presented in the listing 352. In this example, the enterprise may review various statistical information, including, without limitation, the date that a playbook was created, the last date that the playbook was modified, the published date, the current state of the playbook as being active or inactive, the number of communications successfully sent through execution of the playbook, the number of communications queued for sending through the playbook, and the number of communications that generated errors when attempting to be sent through execution of the playbook. It should be appreciated that the information provided in the statistics page 350 may include additional information not shown in FIG. 3F, such as, for example, which recipient list and/or data extension was selected in creation of the playbook. The statistics page 350 may also enable an enterprise to click or interact with any of the playbooks in the listing 352 to discover additional information about the playbook, such as, for example, individual recipient information included in the recipient list and/or data extension targeted by the playbook, recipient metrics associated with opening, clicking, and generally interacting with communications sent through execution of the playbook, and other information.

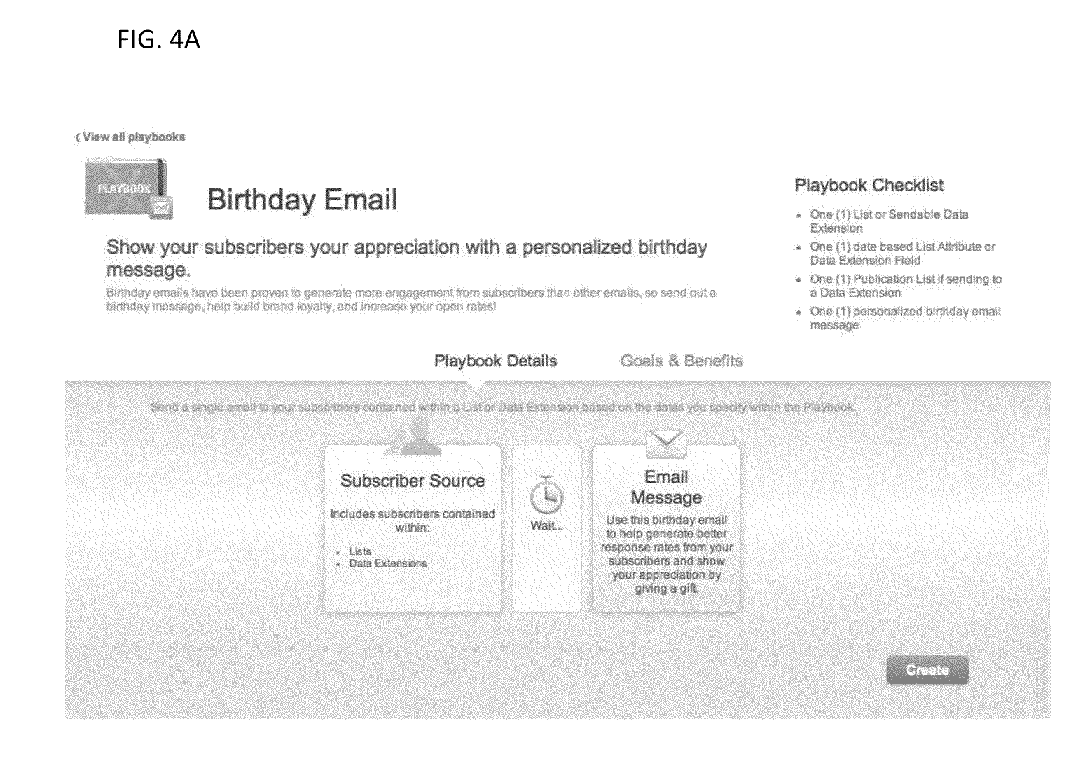

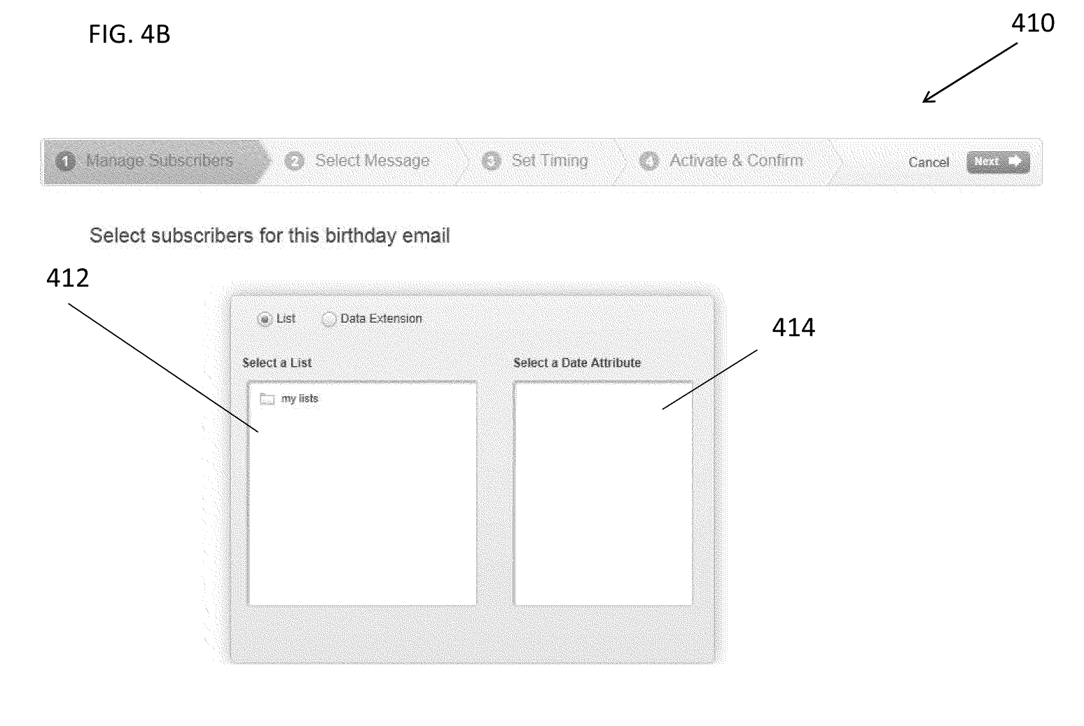

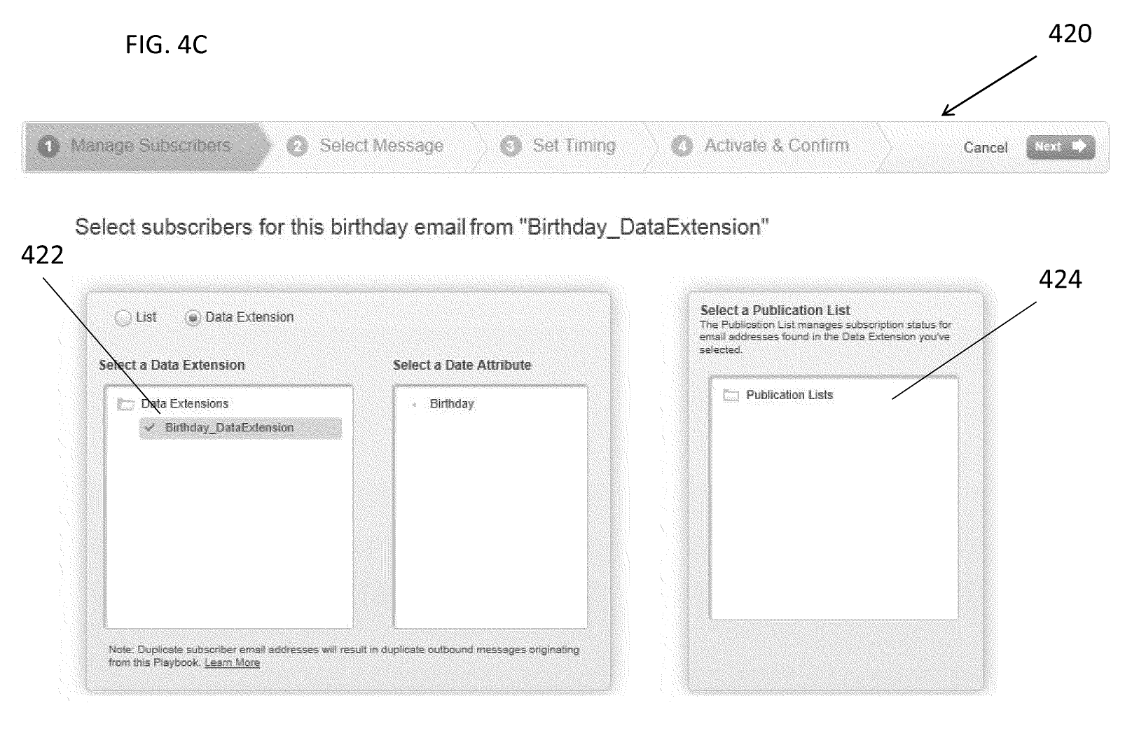

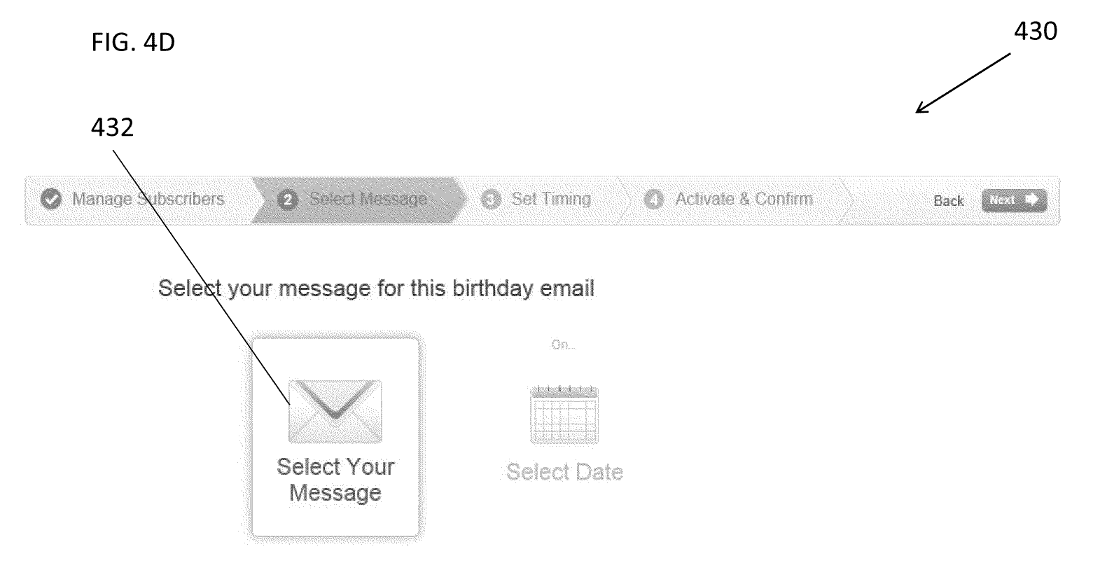

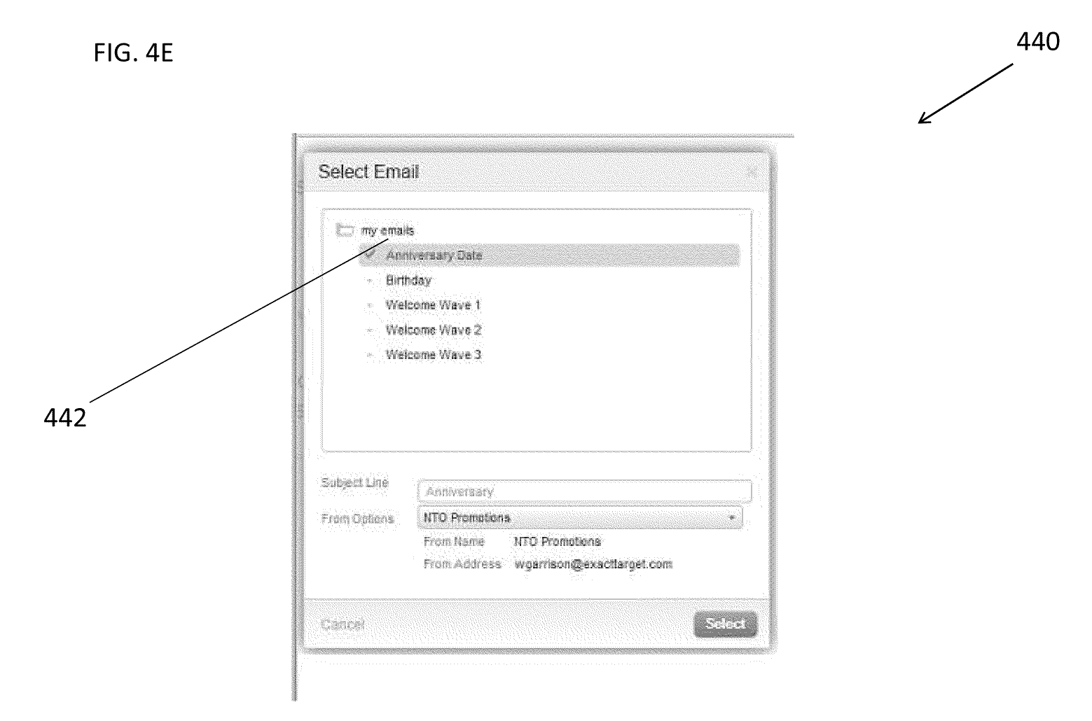

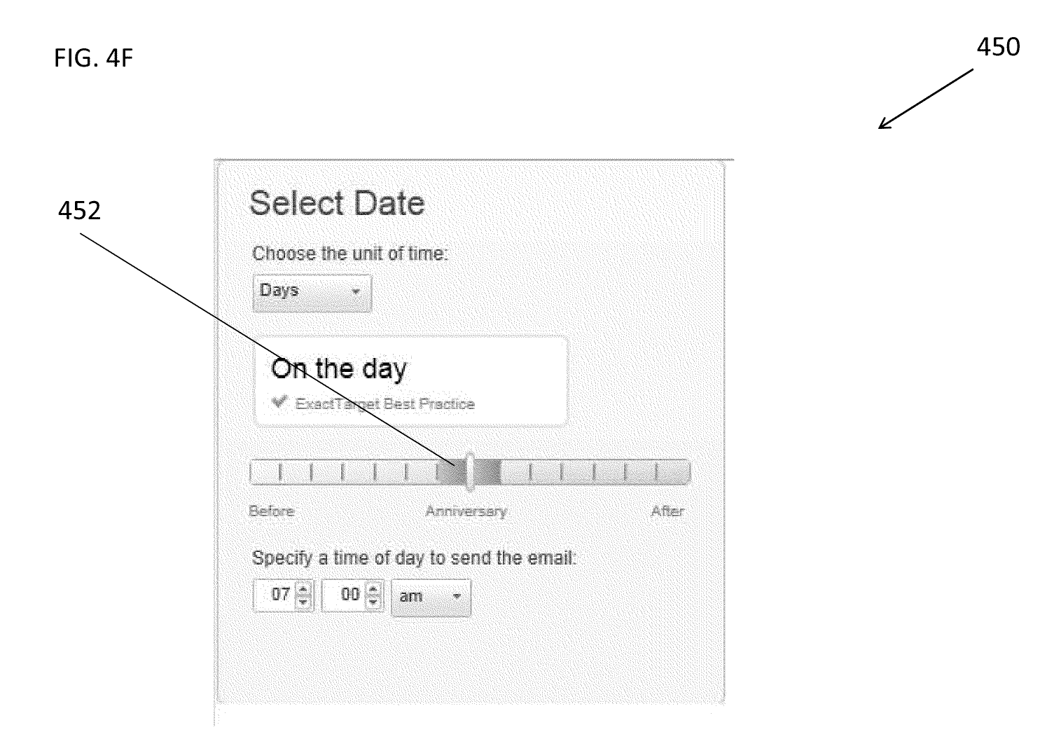

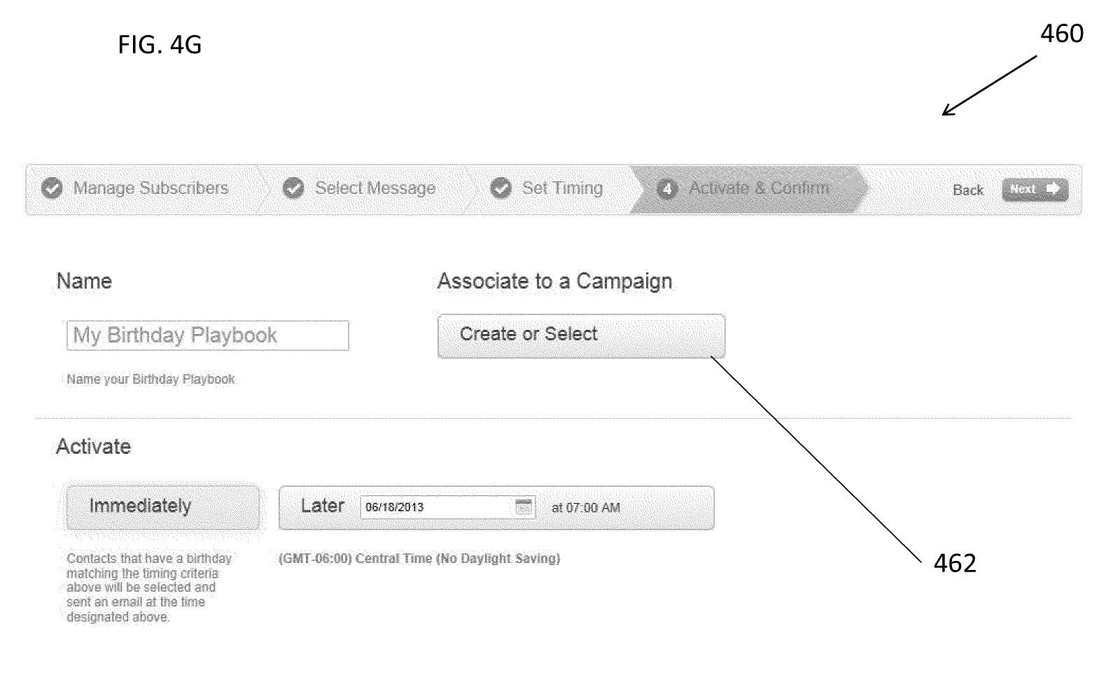

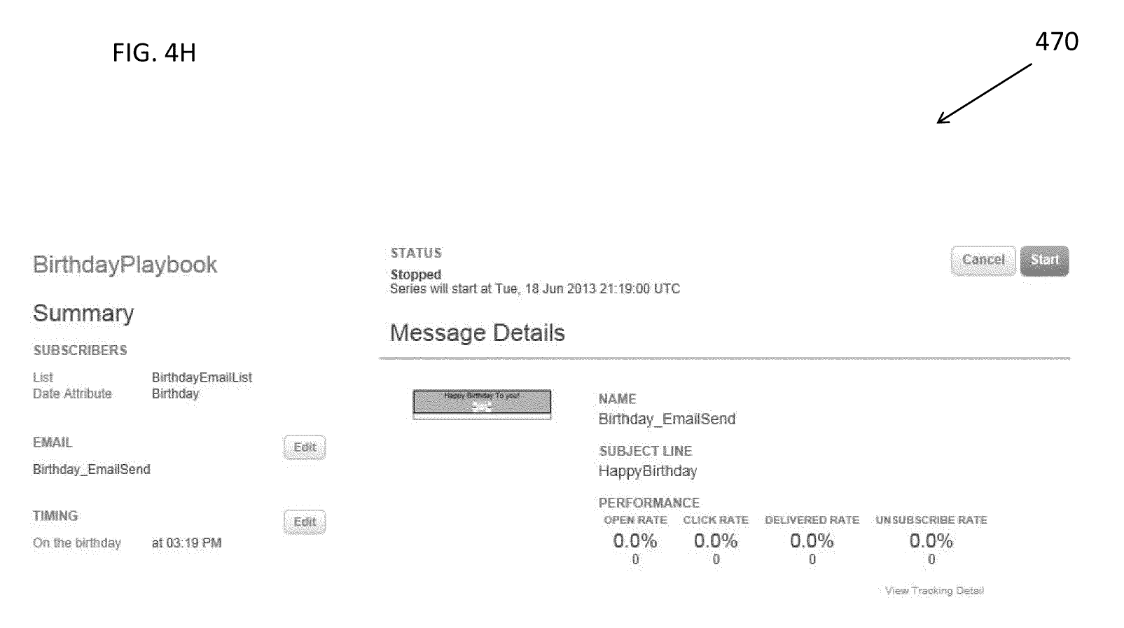

Referring now to FIG. 4A, it is shown a welcome screen for an example playbook that may be used by an enterprise to quickly and efficiently generate targeted marketing communications based on , in this example, a recipient's known birthday. In this example, an enterprise may use a “Birthday Email” playbook to quickly and efficiently generate a campaign to send emails to its subscribers based on stored information within a database which denotes each subscriber's birthday. As shown in FIG. 4A, the playbook may create marketing campaigns based on recipient lists or data extensions with a pre-generated set of content to include in the communication when it is most relevant. Although the playbook is titled “Birthday Email” in FIG. 4A, it should be appreciated that it is within the scope of the present disclosure to create a marketing campaign through execution of a playbook that may send communications based on any trigger date, such as, for example, a holiday, an anniversary, or any other date that may be relevant to a consumer and known by the enterprise. It should be appreciated further that the active date may be stored within a database (such as, for example, a recipient's birthday or anniversary) or may be statically defined by the enterprise at the time of creating the marketing campaign (such as, for example, Christmas or New Year's Day).

Referring now to FIG. 4B, it is shown a graphical user interface 410 directing an enterprise to select subscribers for a birthday communication. As shown in FIG. 4B, the enterprise has selected that subscribers will be identified through one or more recipient lists. The enterprise may select such recipient lists listed in a recipient list window 412. The enterprise may also select an applicable date to trigger generating and sending communications from the playbook. In this example, the enterprise may select such date based on information stored within a database or static information through the date window 414. The date window 414 may include date attributes identified within a database (i.e. “birthday,” “anniversary,” “last purchase”) or may enable an enterprise to manually identify a static date that will be applied for all subscribers selected in the recipient list window 412.

FIG. 4C shows a similar selection interface 420 where the enterprise has selected that recipients will be identified through one or more data extensions in a data extension window 422. The data extensions interface 420, in this example, includes an additional publication list window 424 enabling the enterprise to further limit recipients identified within a data extension based on opt-in and/or opt-out information. As used in the present disclosure, a publication list or suppression list are lists of recipients positively or negatively tied to a specific publication or type of publication, such as, for example a newsletter. A publication list indicates that the recipient desires to receive communications of that publication or publication type from the enterprise whereas a suppression list indicates that the recipient does not wish to receive communications from the enterprise associated with that publication or publication type. A publication list may be used by an enterprise to further delineate types of communications sent by the enterprise to the same recipient. For example, a recipient may opt-in to receiving the enterprise's weekly newsletter. In this example, the enterprise may add the recipient to the enterprise's weekly newsletter publication list. The recipient may also choose to opt-out of receiving the enterprise's daily coupon ad. In this example, the enterprise may add the recipient to a suppression list indicating that the recipient should not receive the daily coupon ad. In this example, the enterprise, then, may send communications tied to the weekly newsletter to the recipient but not communications associated with the daily coupon ad. Publication and suppression lists enable this flexibility.

For example, an enterprise might send newsletters, advertisements, and alerts. Each of these is a different category, so an enterprise may create a separate publication list for each category. When the enterprise sends a newsletter, it may associate the send with the newsletter publication list to identify to the system what kind of content is inside the publication. It should be appreciated, then, that a combination of a data extension and a publication list enables an enterprise to target consumers based on known attributes while complying with such consumers' opt-in and/or opt-out settings.

Referring now to FIG. 4D, it is shown a graphical user interface 430 to select one or more communications to generate and send in marketing campaigns created through the “Birthday Email” playbook. In this example, the enterprise may select a message 432 from pre-generated communications created by the enterprise. As discussed previously, the message selected may be any form of communication and the email indication shown in FIG. 4D is an example. In the event that the enterprise selects a message, a pop-up, new page, or option may generate to enable the enterprise to select from pre-generated communications, such as, for example, as shown in FIG. 4E, the graphical user interface 440 with a communication selection window 442. It should be appreciated that the enterprise may alternatively be directed to a communication designing interface, be asked to upload a template communication, or otherwise create a communication from within the playbook. As discussed previously, the communication may include any form of content, such as, for example, live content, dynamic content, Flash content, images, video, text, and others.

Referring now to FIG. 4F, the enterprise may also be presented with a graphical user interface 450 to select the date to trigger generating and sending communications through a date selection window 452. The enterprise may also select the preferred time of day to generate and send the communication. For example, an enterprise creating a campaign through a playbook directed to generate and send communications on a recipient's birthday may desire to generate and send the communication early in the day, when the recipient is more likely to be able and willing to receive communications rather than in the evening when the recipient may be more likely to be having dinner or at his or her birthday party. In another example, an enterprise may select to generate and send communications with Black Friday coupons included two days prior to Black Friday in order to be available to recipients as such recipients are planning when and where to go for Black Friday. In even another example, an enterprise may desire to generate and send communications on New Year's Day at or around midnight to try to capture the recipient's attention at a relevant time on the holiday. It should be appreciated, then, that a playbook designed to generate and send communications to recipients on a specific configurable date may enable an enterprise to generate and send such communications at a configurable time of day and/or before or after the actual target date.

Referring now to FIG. 4G, it is shown a graphical user interface 460 enabling an enterprise to confirm and activate a playbook according to at least one embodiment of the present disclosure. As shown in FIG. 4G, an enterprise may associate a created playbook with one or more previously created marketing campaigns or a new marketing campaigns through a campaign selection 462. The enterprise may also activate the playbook immediately or at a later time and assign the playbook a certain name. After creation, as shown in FIG. 4H, the enterprise may review statistics regarding its created playbook through a statistics page 470, such as, for example, click rates achieved through communications generated and sent through the campaign associated with the playbook and other information.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method, the method comprising:
receiving, at a server, a request from an enterprise device to generate a marketing campaign using a playbook wizard;
providing for display, to the enterprise device, the playbook wizard, the playbook wizard comprising a plurality of prompts to select a recipient list, select a communication template from a database, and select a communication trigger;
receiving, at the server, a selection from the enterprise device, the selection identifying at least one recipient list, at least one communication template, and at least one communication trigger; and
creating a marketing campaign for each recipient based on the selection.

2. The method of claim 1, further comprising:
receiving a request to activate the marketing campaign; and
generating one or more communications to each recipient in the at least one recipient list based on the communication template.

3. The method of claim 2, further comprising:
receiving a communication activity from at least one recipient of the at least one recipient list, the communication activity indicating at least one of a communication open or clicked link; and
storing the communication activity in the database.

4. The method of claim 3, further comprising:
receiving, at the server, a request from the enterprise device for a statistics page for the marketing campaign, the statistics page configured to present the communication activity.

5. The method of claim 1, wherein the recipient list is a data extension comprising a table generated through aggregation of recipient information from one or more disparate data sources.

6. The method of claim 1, wherein the communication trigger is associated with at least one data attribute stored in the database for each recipient of the at least one recipient list.

7. The method of claim 1, wherein the communication trigger is an indication that a recipient of the at least one recipient list has abandoned a shopping cart.

8. The method of claim 1, wherein the communication template comprises at least one of a dynamic content or live content.

9. The method of claim 1, wherein the selection further comprises a publication list, the publication list being associated with opt-in information for each recipient in the at least one recipient list.

10. A system, the system comprising:
a database;
an enterprise device, the enterprise device configured to transmit a request for a playbook wizard; and
a server, the server configured to receive the request, provide for display, to the enterprise device, the playbook wizard, the playbook wizard comprising a plurality of prompts to select a recipient list, select a communication template from the database, and select a communication trigger, to receive a selection from the enterprise device, the selection identifying at least one recipient list, at least one communication template, and at least one communication trigger, and to create a marketing campaign based on the selection.

11. The system of claim 10, wherein the server is further configured to receive a request to activate the marketing campaign and generate one or more communications to one or more recipients from the at least one recipient list based on the communication template.

12. The system of claim 10, wherein the server is further configured to receive a communication activity from at least one of the recipients of the at least one recipient list, the communication activity indicating at least one of a communication open or clicked link

13. The system of claim 10, wherein the communication trigger is a date.

14. The system of claim 10, wherein the communication trigger is associated with at least one data attribute stored in the database for each recipient of the at least one recipient list.

15. The system of claim 10, wherein the communication trigger is an indication that a recipient of the at least one recipient list has abandoned a shopping cart.

16. A computerized method, the method comprising:
publishing a playbook wizard at a server over a computer network, the server configured to generate a marketing campaign based on inputs to the playbook wizard of a recipient list, a communication template, and a communication trigger from the marketing campaign template;
receiving from an enterprise device the inputs through the playbook wizard over the computer network; and
creating a marketing campaign at the server based on the inputs.

17. The method of claim 16, wherein the communication trigger is a birthday for each recipient in the recipient list, the birthday being stored in a database.

18. The method of claim 17, further comprising:
generating a communication to each recipient of the recipient list based on the communication template upon the birthday associated with each recipient.

19. The method of claim 16, wherein the communication trigger is a date, the method further comprising:
generating a communication to each recipient in the recipient list based on the communication template at a specified time range from the date.

20. The method of claim 16, wherein the communication trigger is an indication that a recipient of the recipient list has abandoned a shopping cart.
